(19) United States
(12) Patent Application Publication
(10) Pub. No.: US 2016/0048907 A1
(43) Pub. Date: Feb. 18, 2016

(54) ELECTRONIC SHELF LABEL DISPLAY APPARATUS AND SYSTEM, AND OPERATING METHOD THEREOF

(71) Applicant: Samsung Electro-Mechanics Co., Ltd., Suwon-si (KR)

(72) Inventors: Young Seo PARK, Suwon-si (KR); Jeong Su SEO, Suwon-si (KR)

(73) Assignee: Samsung Electro-Mechanics Co., Ltd., Suwon-si (KR)

(21) Appl. No.: 14/827,474

(22) Filed: Aug. 17, 2015

(30) Foreign Application Priority Data
Aug. 18, 2014 (KR) 10-2014-0107225
Dec. 5, 2014 (KR) 10-2014-0173569

(51) Int. Cl. G06Q 30/06; G06T 11/60; G06T 1/00

(52) U.S. Cl. CPC G06Q 30/0641; G06T 1/0007; G06T 11/60

(57) ABSTRACT

An electronic shelf label display may include a memory configured to store data of a basic image having a update area and a non-update area, and a communicator configured to receive data of an update image having a blank area and a display area from an external communications device. The electronic shelf label display may include a controller configured to overlap the non-update area of the basic image with the blank area of the update image, and replace the update area of the basic image with the display area of the update image, and thereby form an updated basic image.

### CROSS-REFERENCE TO RELATED APPLICATION(S)

This application claims the benefit under 35 USC 119(a) of Korean Patent Application No. 10-2014-0107225 filed on Aug. 18, 2014, in the Korean Intellectual Property Office, and Korean Patent Application No. 10-2014-0173569 filed on Dec. 5, 2014, in the Korean Intellectual Property Office, the entire disclosures of which are incorporated herein by reference for all purposes.

### BACKGROUND

1. Field

The following description relates to an electronic shelf label display apparatus that is able to change part of an image, an electronic shelf label system, and an operating method thereof.

2. Description of Related Art

In order to display and sell a large number of products in a predetermined space such as a retail store, labels showing information and prices of products have been used. Recently, product information such as price and discount information, necessary for sales of the product, is directly written on a paper label, or paper on which prices and discount information of products are printed according to a standardized norm is displayed in the vicinity of the products.

However, in a case in which paper labels are used as described above, relatively much time and effort may be required, because whenever the prices of products are changed, paper labels of the products should be replaced one by one.

In order to resolve such a problem, attempts to replace paper labels with electronic shelf label displays using electronic devices have been recently made. Here, electronic shelf label displays may rapidly, accurately, and easily change the above-mentioned product information using communications and electronic display technologies.

However, the speed of electronic shelf label displays and the amount of network traffic thereof may be increased, since graphic type electronic shelf label displays deal with large amount of information, and in turn, have large data throughputs. Thus, a system may become unstable or transmission of information may be delayed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an electronic shelf label display apparatus may include a memory configured to store data of a basic image having a update area and a non-update area, a wireless communicator configured to receive, from an external communications device, data of an update image having a blank area and a display area. The electronic shelf label display apparatus may include a controller configured to overlap the non-update area of the basic image with the blank area of the update image and replace the update area of the basic image with the display area of the update image, and thereby generate and updated basic image.

The update area may include one of product information and price information, and the non-update area may include the other of the product information and the price information.

The communicator may be configured to receive the data of the basic image during initial communications with the external communications device, and receive the data of the update image while communicating with the external communications device after the initial communications.

A position of the blank area of the update image may correspond to a position of the non-update area of the basic image, and a position of the display area of the update image may correspond to a position of the update area of the basic image.

The electronic shelf label display apparatus may further include a display configured to display the updated basic image through control by the controller.

In another general aspect, a method of operating an electronic shelf label system may include receiving, at a communicator, data of an update image from an external source, the update image having a blank area and a display area. The method may include updating, by a controller, a basic image having a update area and a non-update area using the data of the update image. The updating of the basic image may include overlapping the non-update area of the basic image with the blank area of the update image and replacing the update area of the basic image with the display area of the update image.

The method may further include receiving, at the communicator, the data of the basic image at the time of initial external communications and storing the received data of the basic image in a memory.

The method may further include displaying the updated basic image.

The update area may include one of product information and price information, and the non-update area may include the other of the product information and the price information.

The display area of the update image may include a same information as information included in the update area, among the product information and the price information.

In another general aspect, an electronic shelf label system may include a server and an electronic shelf label display apparatus. The server may be configured to provide data of an update image having a display area and a blank area. The electronic shelf label display apparatus may be configured to receive the data of the update image from the server to update a basic image having an update area and a non-update area. The electronic shelf label display apparatus may be configured to overlap the blank area of the update image with the non-update area of the basic image and replace the update area of the basic image with the display area of the update image, thereby generating an updated basic image.

The update area may include one of product information and price information, and the non-update area comprises the other of the product information and the price information.

The product information may include at least one of a weight, name, expiration date, origin, manufacturer, and barcode information of a product.

The electronic shelf label display apparatus may be configured to receive the data of the basic image from the server during initial communications with the server, and receive the data of the update image while communicating with the server after the initial communications.

A position of the blank area of the update image may correspond to a position of the non-update area of the basic image, and a position of the display area of the update image may correspond to a position of the update area of the basic image.

The electronic shelf label display apparatus may be configured to display the updated basic image.

Other features and aspects will be apparent from the following detailed description, the drawings, and the claims.

### BRIEF DESCRIPTION OF DRAWINGS

FIG. 1 is a block diagram illustrating an example of an electronic shelf label display apparatus.

FIG. 2 is a view illustrating an example of a basic image stored in an electronic shelf label display apparatus in a form of data.

FIG. 3 is a view illustrating an example of an update image provided to an electronic shelf label display apparatus in a form of data.

FIG. 4 is a view illustrating an example of the basic image of FIG. 2 updated according to the update image of FIG. 3.

FIG. 5 is a diagram illustrating an example of an electronic shelf label system.

FIG. 6 is a flowchart illustrating an example method of operating an electronic shelf label system.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

FIG. 1 is a block diagram illustrating an electronic shelf label display apparatus 100 according to an example embodiment.

Referring to FIG. 1, the electronic shelf label display apparatus 100 includes a controller 110, a communicator 120, an image display 130, a memory 140, and a power supply 150.

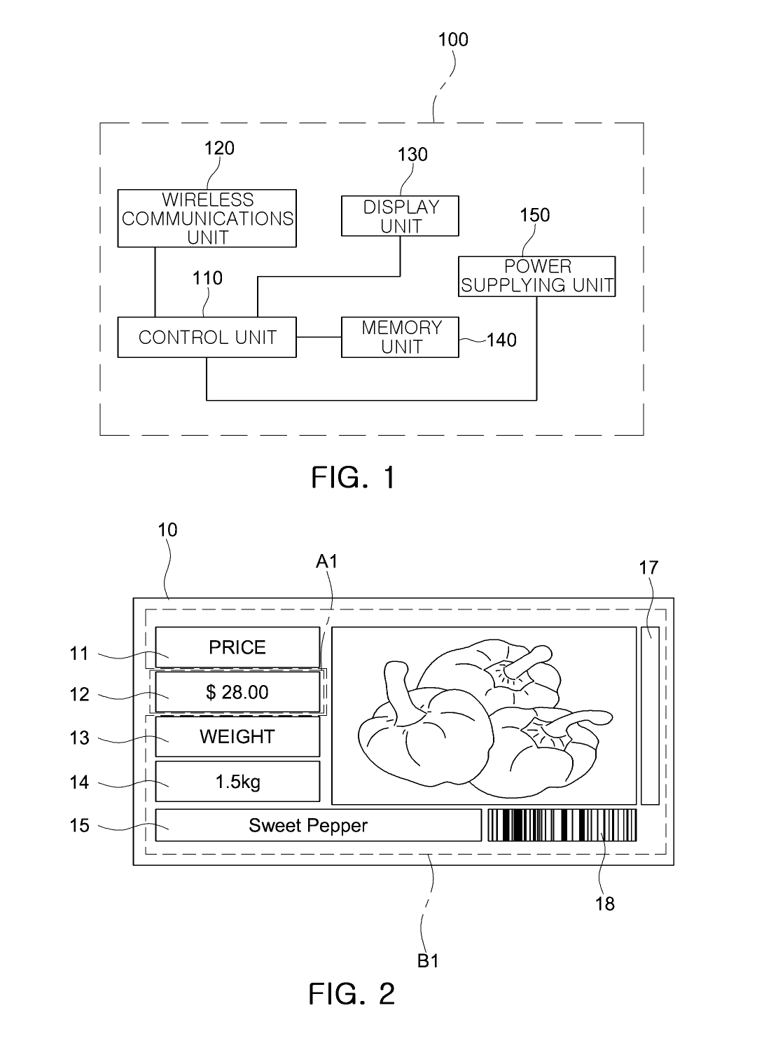

The controller 110 may control general functions of the electronic shelf label display apparatus 100. The controller 110 may output a basic image stored in the memory 140 in a form of data through the display 130, and may update the basic image stored in the memory 140 in the form of data using an update image provided by the communicator 120. A detailed description of the controller 110 outputting and updating a basic image will be provided with reference to FIGS. 2 through 4.

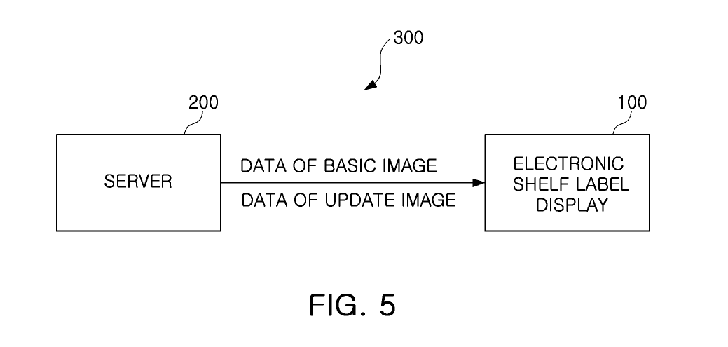

The communicator 120 may be, for example, a wireless communicator, and may transmit and receive data to and from a server 200 (see FIG. 5) or a gateway through a preset wireless communications scheme. In this case, the preset wireless communications scheme may, for example, a Bluetooth, Wi-Fi, Zigbee®, or cellular communications scheme. However, other communications schemes, such as a wired communications scheme, may be used.

In detail, the electronic shelf label display apparatus 100 performs initial communications with the server 200 (see FIG. 5) in the preset communications scheme through the communicator 120. In this case, the electronic shelf label display apparatus 100 may receive data of the basic image from the server 200 (see FIG. 5). Then, the data of the basic image may be stored in the memory 140, and the basic image may also be output through the display 130.

In addition, the electronic shelf label display apparatus 100 may receive the data of the update image in the preset communications scheme while communicating with the server 200 after the initial communications. Then, the controller 110 may update the basic image stored in the memory 140 in a form of data using the update image.

The electronic shelf label display apparatus 100 may not directly receive the data of the basic image or the update image from the server 200, but may receive the data of the basic image or the update image through a gateway (not illustrated).

The display 130 may be a superpower liquid crystal display (LCD) such as e-paper, a bistable LCD, a 7-segment LCD, or the like, with a low level of power consumption. The display 130 may output the basic image stored in the memory 140 in a form of data according to a control of the controller 110, or may output the basic image updated according to the update image to the display.

The memory 140 stores the data of the basic image. In addition, the memory 140 may store the data of the basic image updated by the controller 110.

In this case, the data of the basic image may be received through initial communications with the server 200 (see FIG. 5) as described above, but may be stored in the memory 140 from the first.

In addition, identification information (e.g. MAC address), hourly temperature information, or the like of the electronic shelf label display apparatus 100 may be stored in the memory 140, if necessary.

The power supply 150 supplies operating power to the communicator 120, the display 130, and the memory 140 according to the control of the controller 110.

Operation of an electronic shelf label display may be divided into a passive operation and an active operation, depending on an antenna and a driving type of the power supply 150.

The electronic shelf label display apparatus 100 may be generally designed to operate in a passive manner in terms of power consumption, but may also be operated in a semi-passive manner by additionally installing an auxiliary power source (e.g., a capacitor having high capacity and a battery—not shown) to drive the display 130 or the like.

FIG. 2 is a view illustrating an example of a basic image 10 stored in the electronic shelf label display apparatus 100 according to an example embodiment

Referring to FIG. 2, the basic image 10 includes price information and product information.

In addition, the price information and product information may each include characters or numerals which are directly and visually shown on the display 130 to respectively provide price information and descriptive information of a product. The product information may include descriptive information such as weight, name, expiration date, origin, manufacturer, barcode information, and the like of a product.

In this case, an example of the basic image 10 is illustrated in FIG. 2 and Table 1, however a size of the basic image or information included in the basic image is not limited to the specific example provided.

TABLE 1

| | |
|---|---|
| 11 | Label |
| 12 | Price |
| 13 | Label |
| 14 | Weight |
| 15 | Label |
| 16 | Picture or Icon |
| 17 | Label |
| 18 | Barcode |

The basic image stored in the memory 140 of the electronic shelf label display apparatus 100 may include an update area A1 and a non-update area B1.

The update area A1 may be an area on the basic image 10 including one of price information and product information. The non-update area B1 may be an area on the basic image 10 including the other one of the price information and the product information.

In detail, when the update area A1 includes the price information as illustrated in FIG. 2, the non-update area B1 may include the product information. Hereinafter, the present specification will describe, as an example, a case in which the update area A1 includes the price information. However, the image 10 is not limited to this example.

Thus, referring to FIG. 2, the update area A1 may be an area on which a price 12 is displayed, and the non-update area B1 may be, for example, an entire area of the basic image 10 except for the area A1 on which price 12 is displayed.

The controller 110 may store the data of the basic image 10 received during the initial communications with the server 200 in the memory 140, and output the basic image 10 through the display 130.

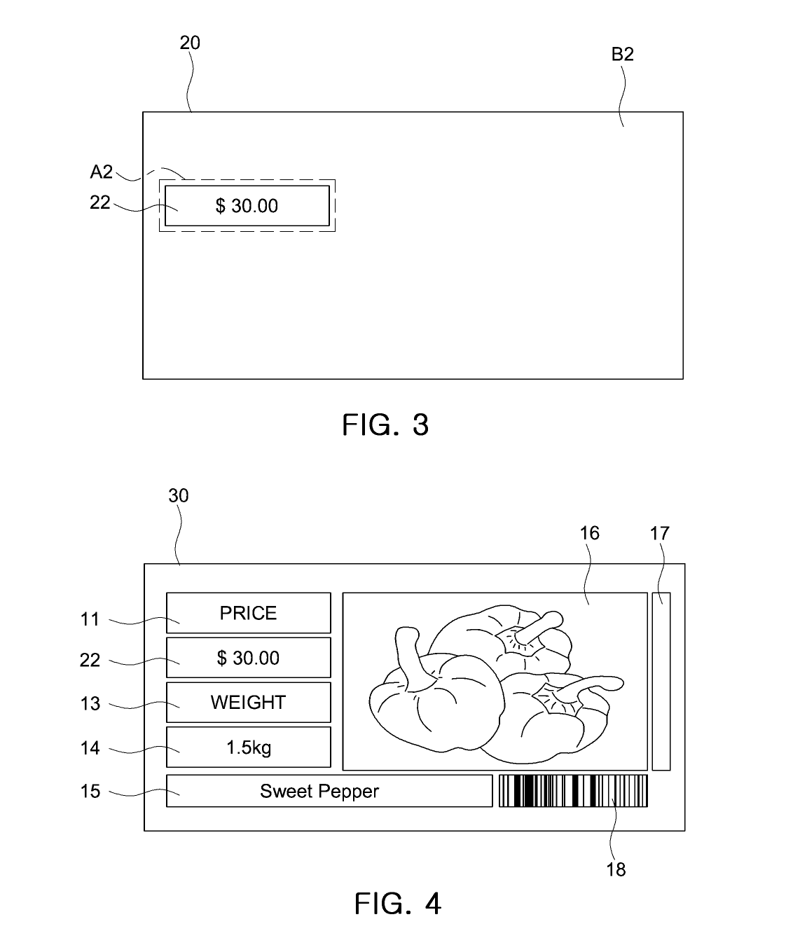

FIG. 3 is a view illustrating an example of an update image 20 provided to the electronic shelf label display apparatus 100 in a form of data according to an example embodiment.

Referring to FIG. 3, the update image 20 includes a display area A2 and a blank area B2.

The display area A2 may be determined to be an area of the basic image 10 on which information needs to be updated in the update image 20. The display area A2 may be, for example, an area on which the price 22 is displayed in the update image 20.

The blank area B2 may be determined to be an area of the basic image 10 on which information does not need to be updated in the update image 20. The blank area B2 may be, for example, an entire area of the update image 20 except for the area A2 on which the price 22 is displayed.

In detail, the display area A2 of the update image 20 may correspond to the update area A1 of the basic image 10 (FIG. 2), and the blank area B2 of the update image 20 may correspond to the non-update area B1 of the basic image 10 (FIG. 2).

Thus, the electronic shelf label display apparatus 100 may update the basic image 10 stored in the memory 140 using the data of the update image 20 provided after initial communications with the server 200. That is, only an area of the basic image 10 on which information needs to be changed may be updated.

A more detailed description of updating information in the basic image 10 will be provided with reference to FIG. 4.

FIG. 4 is a view illustrating an updated basic image 30 which is formed by the basic image 10 of FIG. 2 updated according to the update image 20 of FIG. 3.

Referring to FIG. 4, the electronic shelf label display apparatus 100 receives the data of the update image 20 (FIG. 3) from the server 200 according to the control of the controller 110 to update the basic image 10 (FIG. 2).The controller 110 may update the basic image 10 (FIG. 2) by replacing the update area A1 of the basic image 10 (FIG. 2) with the display area A2 of the update image 20 (FIG. 3) and overlapping the non-update area B1 of the basic image 10 (FIG. 2) with the blank area B2 of the update image 20 (FIG. 3), thereby producing the updated basic image 20. Then, the controller 110 may store an updated basic image 30 in the memory 140 in a form of data and output the updated basic image 30 to the display through the display 130.

Referring to FIG. 2, the price 12 displayed in the update area A1 of the basic image 10 is $28.00. However, as shown in FIG. 4, after the update, area A1 of the basic image 10 (FIG. 2) is replaced with the display area A2 of the update image 20 (FIG. 3), and the price 12 displayed in the update area A1 of the basic image 10 may be updated to a price 22 of $30.00 in the updated basic image 30.

FIG. 5 is a diagram illustrating an electronic shelf label system 300 according to an example embodiment. The electronic shelf label system 300 includes the electronic shelf label display apparatus 100 and the server 200.

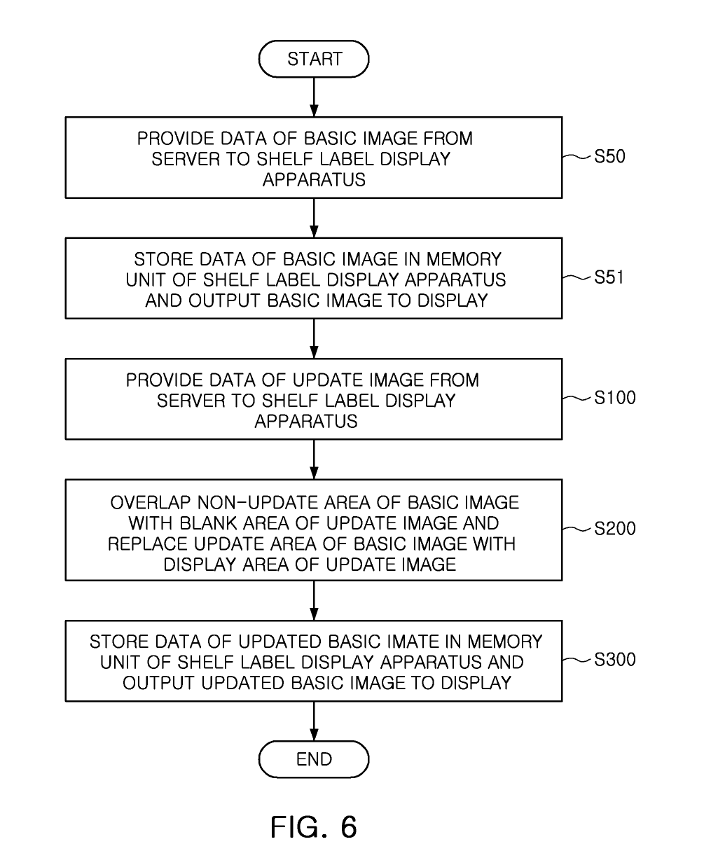

FIG. 6 is a flowchart illustrating a method of operating the electronic shelf label system 300 according to an example embodiment.

Referring to FIG. 6, in operation S50, the server 200 provides the data of the basic image 10 (FIG. 2) having the update area A1 and the non-update area B1 to the electronic shelf label display apparatus 100 at the time of initial communications with the electronic shelf label display apparatus 100. In this case, a wireless communications scheme between the server 200 and the electronic shelf label display apparatus 100 may be preset to be one of a Bluetooth, a Wi-Fi, a Zigbee®, and a Cellular communications scheme.

Then, in operation S51, the electronic shelf label display apparatus 100 stores the data of the basic image 10 (FIG. 2) in the memory 140 (FIG. 1) according to the control of the controller 110 (FIG. 1), and outputs the basic image 10 (FIG. 2) through the display 130 (FIG. 1),In this case, the basic image 10 (FIG. 2) may include the product information and the price information as described above.

Next, in operation S100, the server 200 provides the data of the update image 20 (FIG. 3) to the electronic shelf label display apparatus 100. When there is an area A1 of the basic image 10 (FIG. 2) on which information needs to be changed, or, for example, price information 12 (FIG. 1) of the basic image needs to be updated, the server 200 may designate the area A1 of the basic image 10 on which the price is displayed as the display area A2 in the update image 20 and designate an entire image area B1 except for the area A1 of the basic image 10 on which the price is displayed as the blank area B2 in the update image 20, so as to provide the data of the update image 20 to the electronic shelf label display apparatus 100. The data of the update image 20 (FIG. 3) may be provided to the electronic shelf label display apparatus 100 in a compressed form, whereby a size of data provided by the server 200 is reduced, such that transmission speed may be improved and network traffic may be significantly reduced.

When the electronic shelf label display apparatus 100 receives the data of the update image 20 (FIG. 3) from the server 200, the electronic shelf label display apparatus 100 may, in operation S200, replace the update area A1 of the basic image 10 (FIG. 2) with the display area A2 of the update image 20 (FIG. 3), and may overlap the non-update area B1 of the basic image 10 (FIG. 2) with the blank area B2 of the update image 20 (FIG. 3). As a result, the basic image 10 is updated by the electronic shelf label display apparatus 100 to produce the updated basic image 30.

The updated basic image 30 (FIG. 4) produced by operation S200 may be, in operation S300, output through the display 130 (FIG. 1) and may be stored in the memory 140 in a form of data again.

As set forth above, according to example embodiments, in the electronic shelf label display apparatus 100, the electronic shelf label system 300, and the operating methods thereof, an area of an existing image 10 displayed by the electronic shelf label display apparatus 100 that needs to be updated may be replaced with the updated information, and the rest of the area of the basic image 10 may be overlapped with the existing image 10. Accordingly, the information of the electronic shelf label display apparatus 100 may be easily updated.

In addition, since a compressed form of basic image 10 or update image 20 may be provided by the server 200, and in turn, the size of the data provided by the server 200 may be reduced, speed of communications may be improved and network traffic may be reduced.

The apparatuses, units, modules, devices, and other components (e.g., controller 110, communicator 120, memory 140, power supply 150 and server 200) illustrated in FIGS. 1 and 5 that perform the operations described herein with respect to FIGS. 2-4 and 6 are implemented by hardware components. Examples of hardware components include controllers, sensors, generators, drivers, and any other electronic components known to one of ordinary skill in the art. In one example, the hardware components are implemented by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein with respect to FIGS. 2-4 and 6. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 2-4 and 6 that perform the operations described herein with respect to FIGS. 1 and 5 are performed by a processor or a computer as described above executing instructions or software to perform the operations described herein.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

The display 130 described herein may be implemented using a liquid crystal display (LCD), a light-emitting diode (LED) display, a plasma display panel (PDP), a screen, a terminal, or any other type of display known to one of ordinary skill in the art. A screen may be a physical structure that includes one or more hardware components that provide the ability to render a user interface and receive user input. The screen may include any combination of a display region, a gesture capture region, a touch-sensitive display region, and a configurable area. The screen may be part of an apparatus, or may be an external peripheral device that is attachable to and detachable from the apparatus. The display 130 may be a single-screen display or a multi-screen display. A single physical screen may include multiple display regions that are managed as separate logical display regions permitting different content to be displayed on separate display regions even though they are part of the same physical screen.

The user interface may provide the capability of inputting and outputting information regarding a user and an image. The user interface may include a network module for connecting to a network and a universal serial bus (USB) host module for forming a data transfer channel with a mobile storage medium. In addition, the user interface may include one or more input/output devices, such as a mouse, a keyboard, a touch screen, a monitor, a speaker, a screen, or a software module for controlling the input/output device.

While exemplary embodiments have been illustrated and described above, it will be apparent to those skilled in the art that modifications and variations could be made without departing from the scope of the present invention as defined by the appended claims.

What is claimed is:

1. An electronic shelf label display apparatus comprising:
a memory configured to store data of a basic image comprising an update area and a non-update area;
a communicator configured to receive, from an external communications device, data of an update image comprising a blank area and a display area; and
a controller configured to overlap the non-update area of the basic image with the blank area of the update image and replace the update area of the basic image with the display area of the update image, and thereby generate an updated basic image.

2. The electronic shelf label display apparatus of claim 1, wherein the update area comprises one of product information and price information, and the non-update area comprises the other of the product information and the price information.

3. The electronic shelf label display apparatus of claim 1, wherein the communicator is configured to receive the data of the basic image during initial communications with the external communications device, and receive the data of the update image while communicating with the external communications device after the initial communications.

4. The electronic shelf label display apparatus of claim 1, wherein a position of the blank area of the update image corresponds to a position of the non-update area of the basic image, and a position of the display area of the update image corresponds to a position of the update area of the basic image.

5. The electronic shelf label display apparatus of claim 1, further comprising a display configured to display the updated basic image through control by the controller.

6. A method of operating an electronic shelf label system, comprising:
receiving, at a communicator, data of an update image from an external source, the update image having a blank area and a display area; and
updating, by a controller, a basic image having a update area and a non-update area using the update image,
wherein the updating of the basic image comprises overlapping the non-update area of the basic image with the blank area of the update image and replacing the update area of the basic image with the display area of the update image, thereby generating an updated basic image.

7. The method of claim 6, further comprising receiving, at the communicator, the data of the basic image at the time of initial external communications and storing the received data of the basic image in a memory.

8. The method of claim 6, further comprising displaying the updated basic image.

9. The method of claim 6, wherein the update area includes one of product information and price information, and the non-update area includes the other of the product information and the price information.

10. The method of claim 6, wherein the display area of the update image includes a same information as information included in the update area, among the product information and the price information.

11. An electronic shelf label system comprising:
a server configured to provide data of an update image having a display area and a blank area; and
an electronic shelf label display apparatus configured to
receive the data of the update image from the server to update a basic image having an update area and a non-update area, and
overlap the blank area of the update image with the non-update area of the basic image and replace the update area of the basic image with the display area of the update image, thereby generating an updated basic image.

12. The electronic shelf label system of claim 11, wherein the update area comprises one of product information and price information, and the non-update area comprises the other of the product information and the price information.

13. The electronic shelf label system of claim 12, wherein the product information comprises at least one of a weight, name, expiration date, origin, manufacturer, and barcode information of a product.

14. The electronic shelf label system of claim 11, wherein the electronic shelf label display apparatus is configured to receive the data of the basic image from the server during initial communications with the server, and receive the data of the update image while communicating with the server after the initial communications.

15. The electronic shelf label system of claim 11, wherein a position of the blank area of the update image corresponds to a position of the non-update area of the basic image, and a position of the display area of the update image corresponds to a position of the update area of the basic image.

16. The electronic shelf label system of claim 11, wherein the electronic shelf label display apparatus is configured to display the updated basic image.
